(19) United States
(12) Patent Application Publication
(10) Pub. No.: US 2006/0198371 A1
(43) Pub. Date: Sep. 7, 2006

(54) METHOD AND APPARATUS FOR ANALYZING RELIABILITY OF A FLAG VALUE

(76) Inventors: Ho-Chi Huang, Hsin-Chu Hsien (TW); Chai-Ming Lo, Irvine, CA (US); Wei-Nan Sun, Hsin-Chu Hsien (TW); Ying-Ying Chen, Taipei City (TW); SHIH-CHUN PENG, Taipei City (TW); Ti-Wen Yuan, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 11/306,486

(22) Filed: Dec. 29, 2005

Related U.S. Application Data
(63) Continuation-in-part of application No. 10/904,543, filed on Nov. 16, 2004.

(30) Foreign Application Priority Data
Apr. 8, 2004 (TW) 093109821

(51) Int. Cl. H04L 12/56

(52) U.S. Cl. 370/389

(57) ABSTRACT

A method for analyzing the reliability of a flag value carried by a current block is disclosed. The method includes: determining whether the current block is a dummy block, and determining the flag value as invalid if the current block is determined as a dummy block. The step of determining the current block is a dummy block can be implemented through two methods. The first method is to utilize information (signal quality indicators) of the current block and a previous block to perform the dummy block determination. The second method is to only utilize information (including the signal quality indicators and coded USF correction indicators) of the current block to generate a determination value through substituting the information into a predetermined equation, and to perform the dummy block detection according to the determination value.

### CROSS REFERENCE TO RELATED APPLICATIONS

This application is a continuation-in-part continual in part application and claims the benefit of U.S. application Ser. No. 10/904,543, which was filed on No. 11/16/2004, and entitled “METHOD AND APPARATUS FOR DETECTING RELIABILITY OF FLAG VALUE”

### BACKGROUND

The disclosure relates to electronic communication systems, and more particularly, to determining the reliability of an uplink status flag value in a received block in an electronic communication system.

In a GPRS (General Packet Radio Service) or EGPRS (Enhanced General Packet Radio Service) class communication system according to the related art, a base station assigns an uplink time slot according to communication system resources and user end device requests. In order to allocate these time slots, each user end device is given a user identifier. When the base station decides to allocate an uplink time slot to a user end device, the base station includes the user identifier in an uplink status flag (USF), encodes the USF, and then puts the encoded USF into a transmission block, which is then transmitted to the user end device. The user end device receives the block and decodes the value of the USF. If the value of the USF is equal to the user identifier, then the user end device can transmit data to the base station in the next time slot.

Please refer to FIG. 1. FIG. 1 shows a block diagram of a conventional transmitter 40 and receiver 50. For example, the transmitter 40 could be a GPRS communication system base station and receiver 50 could be a GPRS communication system user end device such as a GPRS handset. The transmitter 40 includes an antenna 41, a radio frequency (RF) transmitting module 42, an interleaver 44, a channel encoder 46, and a USF pre-coder 48. The receiver 50 includes an antenna 51, an RF receiving module 52, an equalizer 54, a deinterleaver 55, a channel decoder 56, a coding scheme decoder 57, and a USF decoder 58.

When the base station decides to allocate an uplink time slot to a user end device, the base station includes the user identifier of the user end device in an uplink status flag (USF), which together with other data including user data and corresponding control data, form a data packet 20 as shown in FIG. 2. As shown in FIG. 2, the USF value is stored in a first section 20a of the data packet 20 and the other data is stored in the remaining portion 20b of the data packet 20. The USF value is first passed to the USF pre-coder 48 where it undergoes pre-coding according to an assigned coding scheme. According to the GPRS or the EGPRS related art communication system standards, there are in total four possible coding schemes: a first coding scheme CS1, a second coding scheme CS2, a third coding scheme CS3, and a fourth coding scheme CS4. For a more detailed explanation of the four coding schemes CS1-CS4, please refer to the GPRS or the EGPRS communication system standards. The following is only a simple explanation of one characteristic of the coding schemes. The USF is formed by a 3-bit data value, and after passing the USF pre-coder 48 when using the first coding scheme CS1, the output of the USF pre-coder 48 is still a 3-bit data value. However, when using the second and third coding schemes CS2, CS3, the output of the USF pre-coder 48 is a 6-bit data value, and when using the fourth coding scheme CS4, the output of the USF pre-coder 48 is a 12-bit data value.

After pre-coding, the USF value (hereinafter referred to as the pre-coded USF value) and the other data stored in the remaining portion 20b of the data packet 20 in FIG. 2 are together passed to the channel encoder 46. Using a GPRS system as an example, the channel encoder 46 is a convolution encoder having a code rate of ½. When using the first coding scheme CS1, the convolution encoded USF value (hereinafter referred to as the coded USF value) is a 6-bit data value. However, when using the second to fourth coding schemes, the coded USF value is a 12-bit data value. Furthermore, in a GPRS system using the fourth coding scheme CS4, the channel encoder 46 does not play any role and the coded USF value remains a 12-bit data value at the output of the channel encoder 46. From the above, it can be seen that when using the first coding scheme CS1, the coded USF value is 6 bits in length, and when using the second to fourth coding schemes CS2-CS4, the coded USF value is 12 bits in length. After passing the channel encoder 46, the output forms a data packet 22, as shown in FIG. 3. The coded USF value is positioned in the first section 22a of the data packet 22, and the other data is positioned in the remaining portion 22b of the data packet 22.

Because the original USF value is 3 bits in length, there are 8 possible combinations of binary USF values. After passing through the coding process performed by the USF pre-coder 48 and the channel encoder 46, there are still only eight possible values. These values are referred to as the coded USF set. Different coding schemes CS may have different coded USF sets.

Concerning the output of the channel encoder 46, in a GPRS system, this output may also pass through a puncturing stage (not shown) to modify the code rate. Please refer to the GPRS system standard for detailed information. Afterwards, the output passes through the interleaver 44, which performs an interleaving operation to change the order of the data in the data packet 22 shown in FIG. 3. Finally, the result of the interleaving operation is combined together according to the coding scheme and passed to the RF transmitting module 42.

FIG. 4 shows the structure of a block 10 transmitted by a GPRS RF transmitting module 42. The block 10 includes four bursts 12a, 12b, 12c, and 12d. According to the GPRS system standard, these four bursts are further divided into fields: 14a, 14b, 14c, 14d; 16a, 16b, 16c, 16d; and remaining fields (not shown). After the outputted result of the interleaver 44 is passed to the RF transmitting module 42, it is divided into four parts that are filled in the four fields 14a, 14b, 14c, 14d. The RF transmitting module 42 further encodes the coding scheme and the result is divided into four parts and filled in the four fields 16a, 16b, 16c, 16d. After the content of each burst is generated, the entire block 10 undergoes modulation and is then transmitted as an RF signal by the antenna 41.

The RF receiving module 52 of the receiver 50 uses the antenna 51 to receive the RF signal transmitted by the transmitter 40. Regarding the receiver 50, the RF receiving module 52 is electrically connected to the antenna 51 and performs amplification, filtering, demodulation, etc., to down-convert the RF signal into a baseband signal. Next, the equalizer 54 performs equalization to compensate for inter-symbol interference (ISI) present in the baseband signal. The outputted result of the equalizer 54 is passed to the deinterleaver 55 to assemble the content of each field 14a, 14b, 14c, 14d and return the order of the data packet 22 to its same state as that before the interleaving state, which is equivalent to the data packet 22 shown in FIG. 3. Afterwards, the result is passed to the channel decoder 56, which performs channel decoding to generate a decoded data packet equivalent to the data packet 22 shown in FIG. 2. This is then passed upward to the next layer in the communication protocol for further processing.

In the related art, the output of the equalizer 54 is input into a coding scheme decoder 57 where, according to information stored in the fields 16a, 16b, 16c, 16d located in the received block, the coding scheme CS is determined. The output of the deinterleaver 75 is input into a USF decoder 58 where the USF value is retrieved, shown as the first portion 22a in FIG. 3. After USF decoding is complete, the USF value is passed to an upper level of the communication protocol to decide whether or not the next block is allocated for use by the user end device.

As mentioned above, the base station in a GPRS system uses eight different USF values to represent and distinguish eight different user end devices. Thus, after the USF decoder 58 has received the coded USF value, the USF decoder 58 further calculates the correlation between the received coded USF value and the content of the coded USF value and thereby obtains eight correlation indicators. The USF decoder 58 outputs the USF value corresponding to the largest of these eight correlation indicators as its output.

If the USF decoder 58 of a user end device incorrectly decodes the USF value, it will seriously degrade the transmission stability between the base station and the user end devices. Typically, the user end device uses two different types of timers to control the communication link between the base station and the user end device. As specified in the GPRS system standard, the first timer type is a T3180 timer and the second timer type is a T3182 timer. For each instance when the user end device receives its USF, the user end device restarts the T3180 timer thereby waiting for the base station to send the next USF. If during a predetermined time period specified by an initial setting of the T3180 timer, for example within five seconds, the user end device has not received its USF sent by the base station, the T3180 timer will timeout. In this case, if the base station has not assigned the user end device the right to transmit a packet within the predetermined time period, the user end device will discontinue communications with the base station and begin retrying link communications. Conversely, if the user end device receives its USF within the predetermined time period, the T3180 timer is simply restarted for another timing operation.

Furthermore, after the user end device has transmitted a packet, the user end device will start the T3182 timer and wait for the base station to respond with an ACK/NACK control message. An ACK (acknowledgement) control message indicates that the base station has properly received the packet transmitted by the user end device, while a NACK (negative acknowledgement) message indicates that the base station did not receive the packet transmitted by the user end device, or the received packet is not correct. Therefore, if the user end device does not receive the response from the base station within a predetermined period of time specified by the initial setting of the T3182 timer, for example five seconds, the T3182 timer will timeout. This means the communication link between the user end device and the base station will again be interrupted because the user end device will disconnect the communication link and begin trying to reestablish the communication link.

The errors in decoding by the USF decoder 58 generally result in the following two situations. Firstly, the user end device sends a packet to the base station and restarts the T3180 timer. The base station sends a USF to the user end device permitting the user end device to transmit the packet to the base station, but the user end device USF decoder incorrectly decodes the USF. In this situation, the user end device will continue waiting for a USF until a timeout is reached by the T3180 timer. This causes the user end device to discontinue communications with the base station and begin retrying for a new communication link. In a second situation, the base station does not send a USF to the user end device, however, a decoding error in the USF decoder 58 causes the USF value in the block to be decoded as the user end device's corresponding USF. This causes the user end device to mistakenly transmit a packet to the base station. This unauthorized transmission by the user end device interferes with another user end device's authorized transmission. In addition to this, because the user end device mistakenly believes it is receiving its USF, it will continuously restart the T3180 timer, which will not be able to normally timeout. This prevents the communication link between the base station and the user end device from being disconnected. On the other hand, after the user end device has transmitted a packet, it will start the T3182 timer and wait for the base station to respond with an ACK/NACK message. Because the base station cannot receive the improper packet send by the user end device, the base station will not send a response to the user end device and the T3182 timer will timeout. Therefore, the user end device mistakenly disconnects the communication link with the base station and begins retrying for a new communication link.

In summery, noise and interference in a communication system may cause a user end device to mistakenly decode a received USF to match the user end device's own USF value. Because of this, the T3180 timer will mistakenly timeout and the communication link will be disconnected, or the T3180 timer will not be able to timeout and the communication link will be unable to disconnect. Additionally, in a GPRS system, the base station will occasionally send a dummy burst, and this dummy burst will not necessarily contain any USF data. In this case, a related art user end device will still perform a USF decoding operation and use the resulting USF value. This may cause the communication link to be interrupted and will significantly influence the throughput and stability of the communication link between the user end device and the base station. For these reasons, a related art GPRS handset is extremely susceptible to errors caused by mistaken USF decoding, which degrades communication with the base station. It would be beneficial to find a solution to this problem.

### SUMMARY

One objective is therefore to provide a method and apparatus for determining the reliability of USF value included in a received block according to signal quality indicators, signal power values and coded USF correlation indicators for the bursts in the received block, to solve the above-mentioned problems.

According to an exemplary embodiment of the claimed invention, a method of analyzing a reliability of a flag value outputted by a transmitter is disclosed. After the transmitter has encoded the flag value, the flag value is included in a current block. The method comprises: receiving a previous block transmitted prior to the current block and the current block, the current block and the previous block each including a plurality of bursts; reading an encoded flag value transmitted via the current block and decoding the encoded flag value to obtain the flag value; determining whether the current block is a dummy block according to the bursts of the previous block and the current block; and determining the flag value as invalid if the current block is determined as a dummy block.

According to another exemplary embodiment of the claimed invention, a flag reliability analysis apparatus for analyzing a reliability of a flag value outputted by a transmitter is disclosed. The transmitter has encoded the flag value such that the flag value is included in a current block. The flag reliability analyzing device comprises: a receiving module, for receiving a previous block transmitted prior to the current block and the current block, reading an encoded flag value transmitted via the current block, and decoding the encoded flag value to obtain the flag value; wherein each of the current block and the previous block comprises a plurality of bursts; and a dummy block detecting module, for determining whether the current block is a dummy block according to the bursts of the previous block and the current block and determining the flag value as invalid if the current block is determined as a dummy block.

According to another exemplary embodiment of the claimed invention, a method of analyzing the reliability of a flag value outputted by a transmitter is disclosed. After the transmitter has encoded the flag value, the flag value being included in a current block. The method comprises receiving the current block, the current block including a plurality of bursts; reading an encoded flag value transmitted via the current block and decoding the encoded flag value to obtain the flag value; calculating signal quality indicators of each burst of the current block, and determining a block quality indicator according to the signal quality indicators; performing a correlation operation on the encoded flag value and all possible values of the coded flag value to obtain a plurality of coded flag correlation indicators and then determining an specific indicator according to the coded flag correlation indicators; performing a predetermined calculation utilizing the block quality indicator and the specific indicator to obtain a determination value; and determining that the current block is a dummy block if the determination value is less than a threshold and determining that the flag value as invalid if the current block is determined as a dummy block.

According to another exemplary embodiment of the claimed invention, a flag reliability analysis apparatus for analyzing the reliability of a flag value outputted by a transmitter is disclosed. After the transmitter has encoded the flag value, the flag value is included in a current block. The flag reliability analysis apparatus comprises: a receiving module for receiving the current block including a plurality of bursts, reading an encoded flag value transmitted via the current block and decoding the encoded flag value to obtain the flag value, calculating signal quality indicators of each burst of the current block, determining a block quality indicator according to the signal quality indicators, performing a correlation operation on the encoded flag value and all possible values of the coded flag value to obtain a plurality of coded flag correlation indicators and then determining an specific indicator according to the coded flag correlation indicators, and the receiving module comprises: a calculation module, for performing a predetermined calculation utilizing the block quality indicator and the specific indicator to obtain a determination value; and a dummy block detecting module, for determining that the current block is a dummy block if the determination value is less than a threshold and determining that the flag value as invalid if the current block is determined as a dummy block.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a receiver and transmitter according to the related art.

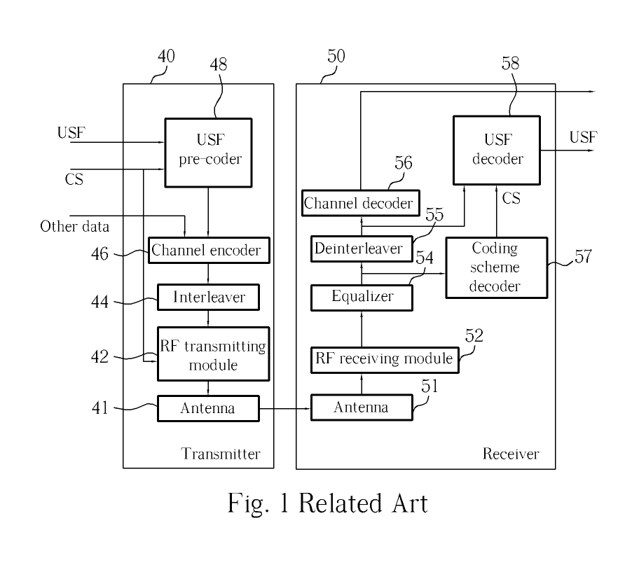

FIG. 2 is a data packet according to the related art.

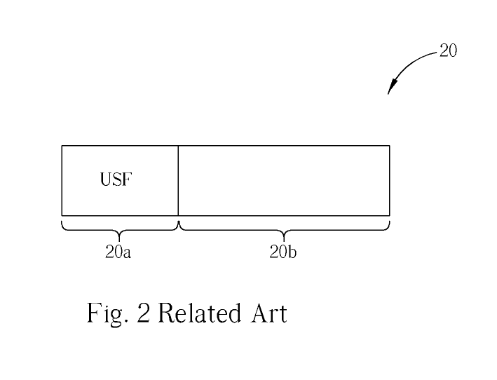

FIG. 3 is an encoded data packet according to the related art.

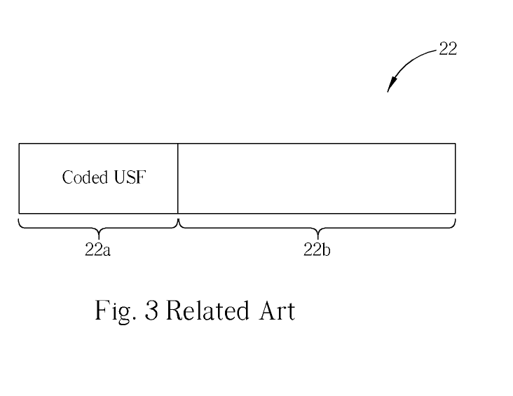

FIG. 4 a detailed diagram showing the structure of a block transmitted by a GPRS RF transmitter according to the related art.

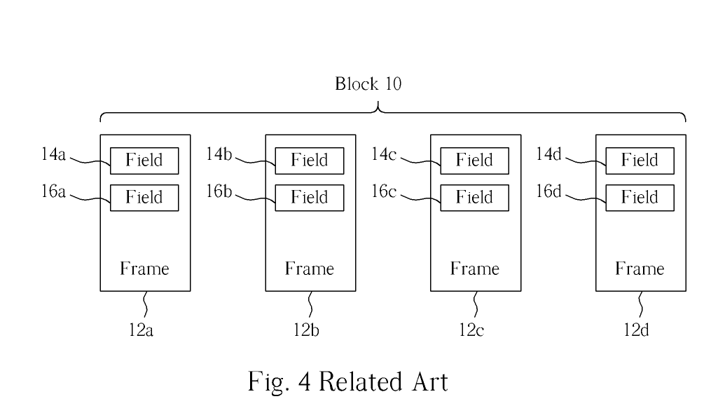

FIG. 5 is a block diagram of a receiver according to the present invention.

FIG. 6 is a flowchart describing the USF reliability analysis operation performed in the receiver shown in FIG. 5.

FIG. 7 is another flow chart describing the USF reliability analysis operation performed in the receiver shown in FIG. 5.

FIG. 8 is a flow chart integrating the flow charts FIG. 6 and FIG. 7.

### DETAILED DESCRIPTION

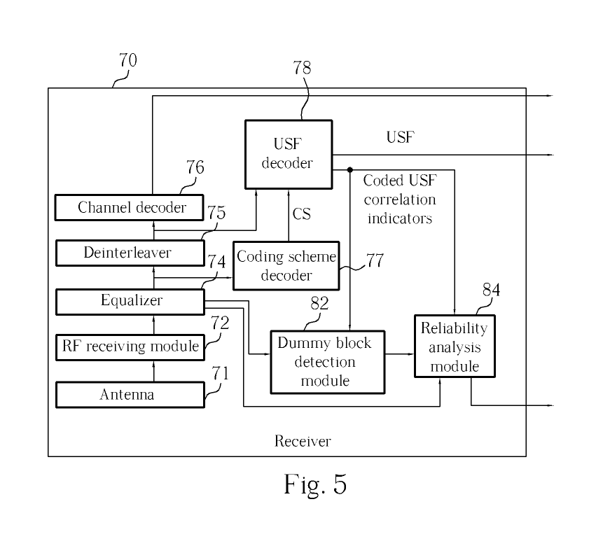

Please refer to FIG. 5. FIG. 5 shows a block diagram of a receiver 70 according to an embodiment of the present invention. In this embodiment, the receiver 70 is a user end device (such as a GPRS handset) in a GPRS system, wherein a corresponding transmitter is a GPRS system base station. As the operation of the transmitter has already been explained, a repeated description is hereby omitted. The receiver 70 includes an antenna 71, an RF receiving module 72, an equalizer 74, a deinterleaver 75, a channel decoder 76, a coding scheme decoder 77, and a USF decoder 78. With the exception of the equalizer 74, the operation of these components is the same as has already been described for the related art. As such, a repeated description is hereby omitted. According to the present invention, the receiver 70 further includes a dummy block detection module 82 and a reliability analysis module 84.

The dummy block detection module 82 is electrically connected to the equalizer 74 and the USF decoder 78 for determining whether the block transmitted by the transmitter to the receiver 70 is a dummy block. Additionally, the reliability analysis module is electrically connected to the equalizer 74, the USF decoder 78, and the dummy block detection module 82 for performing an analysis on the output of the USF decoder 78 to thereby generate a USF reliability signal.

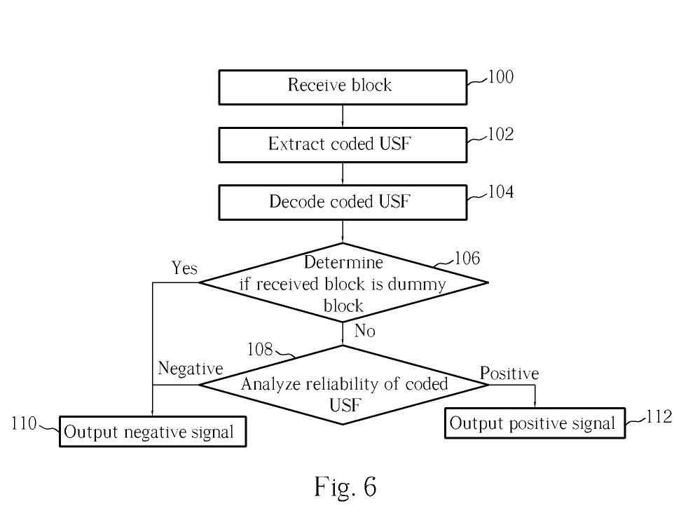

In order to further explain the USF reliability analysis performed in the receiver 70 according to the present invention, please refer to FIG. 6. FIG. 6 shows a flowchart describing the USF reliability analysis operation performed in the receiver 70 shown in FIG. 5. The flowchart includes the following steps:

Step 100: Receive a block.

Step 102: According to the received block, extract an encoded USF value.

Step 104: Decode the coded USF value to obtain a decoded USF result.

Step 106: Determine whether the received block is a dummy block. If yes, proceed to step 110; otherwise, proceed to step 108.

Step 108: Analyze the reliability of the encoded USF value. If the result is negative, proceed to step 110; otherwise, proceed to step 112.

Step 110: Output a negative signal to negate the reliability of the decoded USF result, which indicates the decoded USF result is unreliable.

Step 112: Output a positive signal to affirm the reliability of the decoded USF result, which indicates the decoded USF result is reliable.

The preferred embodiment of the present invention is used in a GPRS system. Concerning the operation of the receiver 70, the process starting from the receiver 70 receiving the received block (step 100), extracting an coded USF value (step 102) according to the received block, and decoding the coded USF value to obtain a decoded USF result (step 104) according to the received coded USF value, is substantially the same as already explained for the related art and is therefore not repeated here. The following description instead focuses on the features of the present invention.

According to the present invention receiver 70, besides using the equalizer 74 to compensate for the inter symbol interference (ISI) present in the base band signal, the equalizer 74 is used to calculate a signal quality indicator and signal power level for each burst. Each burst's signal quality indicator is passed to the dummy block detection module 82, and each burst's power level is passed to the reliability analysis module 84. The signal quality indicator is a numerical value used to correspond to the quality situation of the burst. As an implementation example, the signal quality indicator could be a signal to noise ratio.

Because it is already known that the dummy block does not contain a valid USF value, the coded USF correlation indicators generated by the USF decoder 78 should all be very small. Therefore, when all the correlation indicators are very small, this indicates the block is possibly a dummy block. Additionally, it is already known that another characteristic of a dummy block is that each burst in the dummy block does not pass through encoding protection, and has been carefully designed such that the signal quality indicator of each burst in a dummy block will have a low value. Because of this, when the signal quality indicator is of a low value, this represents that the burst is possibly a dummy burst. Using the above mentioned dummy block and dummy burst characteristics, the dummy block detection module 82, according to each burst's signal quality indicator, and/or coded USF correlation indicators determines whether or not the block is a dummy block. Using these guidelines for step 106, there can be several different implementations as described in the following examples.

A first method for determining dummy blocks by the detection module 82 involves calculating an average signal quality indicator Q_{A} for all the bursts in the received block. If the average value Q_{A} is less than a predetermined level, determine the received block to be a dummy block. Otherwise, determine the received block to not be a dummy block.

A second method for determining dummy blocks by the detection module 82 involves determining whether each burst in the received block is a dummy burst. If a burst's signal quality indicator is less than a predetermined level, determine the burst to be a dummy burst. If the number of dummy bursts in the received block is greater than a predetermined number, determine the received block to be a dummy block.

A third method for determining dummy blocks by the detection module 82 involves if the coded USF correlation indicators are all less than a predetermined value, determining the received block to be a dummy block.

A fourth method for determining dummy blocks by the detection module 82 involves if the average signal quality indicator Q_{A} for all the bursts in the received block is less than a predetermined level, or if the coded USF correlation indicators are all less than a predetermined value, determining the received block to be a dummy block.

Due to the fourth method for determining dummy blocks, a fifth method for determining dummy blocks by the detection module 82 involves if the average signal quality indicator Q_{A} is less than another predetermined level and the coded USF correlation indicators are all less than another predetermined value, determining the received block to be a dummy block.

Furthermore, the present invention can simultaneously utilize the signal quality indicators and coded USF correlation indicators to determine whether the received block is a dummy block. For example, the present invention can first determine a block quality indicator. The block quality indicator can be the above-mentioned average signal quality indicator Q_{A}, or a maximum of all signal quality indicator Q_{M}. Furthermore, the present invention also utilizes a maximum of all coded USF correlation indicators C_{M}, and calculates a difference between a first maximum and a second maximum of all correlation indicators C_{D}.

And then, a sixth method for determining dummy blocks by the detection module 82 involves substituting the block quality indicator and one of the maximum C_{M} and the difference C_{D} into a linear equation, and the received block is determined as a dummy block according to the calculation result. In this embodiment, the linear equation can be defined as “aX+b≦Y”, where X is the block quality indicator, Y is the maximum C_{M} or the difference C_{D}. In this embodiment, if the variables X and Y comply with the inequality “aX+b≦Y”, the current block is regarded as a dummy block.

For example, the receiver 70 can comprise a calculation unit, which can substitute the block quality indicator and one of the maximum C_{M} and the difference C_{D} into the linear equation. Therefore, the detection module 82 can determine whether the received block is a dummy block according to the calculation result.

Please note, the parameters a and b in the linear equation “aX+b=≦Y” can be determined according to different design choices. Obviously, the parameters a and b directly influence the result of determining the dummy block. Therefore, the designer can choose different parameters such that the entire circuit can have a better accuracy of determining the dummy block. This change also obeys the spirit of the present invention.

Moreover, another determination method is to check whether the X≦a, and Y≦b. That is, if calculation unit determines that X≦a and Y≦b, the detection module 82 can determine whether the received block is a dummy block.

Similarly, the parameters a and b can be determined according to the different design choices. This change also obeys the spirit of the present invention.

Similarly, the afore-mentioned signal quality indicator (block quality indicator) can be implemented by the signal-to-noise ratio, or other information capable of indicating the signal quality. For example, power of each burst or bit error rate of each burst can be both utilized as the signal quality indicator. This change also obeys the spirit of the present invention.

In step 108, the reliability analysis module 84 determines the reliability of the coded USF value according to the coded USF correlation indicators, and/or each burst's signal power. When the reliability analysis mode 84 receives the result outputted by the dummy block detection module 82, if the dummy block detection module 82 determines the received block to be a dummy block, the reliability analysis module 84 outputs a negative signal. This indicates a poor reliability for the USF value in the received block. If the dummy block detection module 82 does not determine the received block to be a dummy block, the reliability analysis module 84 determines the reliability of the USF value according to the coded USF correlation indicators.

When the decoded USF value matches the USF value of the user end device, the corresponding coded USF correlation indicator will be the highest while the other coded USF correlation indicators will be relatively lower. Conversely, if the largest of the coded USF correlation indicators do not have particularly large values, this indicates the decoded USF value outputted by the USF decoder 78 is not very reliable. Using this logic, in step 108, analyzing the received coded USF value can have several implementations as shown in the following examples.

A first reliability analysis method involves obtaining a largest value C₁ and an average value C_{A} of the coded USF correlation indicators. If the difference between the largest value C₁ and the average value C_{A} is greater than a predetermined value, affirm the reliability of the USF value and the reliability analysis module 84 outputs a positive signal. Otherwise the reliability analysis module 84 outputs a negative signal.

A second reliability analysis method involves obtaining a largest value C₁ and a second largest value C₂ of the coded USF correlation indicators. If the difference between the largest value C₁ and the second largest value C₂ is greater than a predetermined value, affirm the reliability of the USF value and the reliability analysis module 84 outputs a positive signal. Otherwise the reliability analysis module 84 outputs a negative signal.

Further, the signal power level for each burst also reflects the USF reliability. When the signal power level for each burst is too low, this indicates the USF value outputted by the USF decoder 58 may not be very reliable. Using this logic, in step 108, analyzing the coded USF value can have several more implementations as shown in the following examples.

A third reliability analysis method involves obtaining a largest signal power level P₁ for the bursts. If the largest level P₁ is greater than a predetermined level, affirm the reliability of the USF value and the reliability analysis module 84 outputs a positive signal. Otherwise the reliability analysis module 84 outputs a negative signal.

A fourth reliability analysis method involves obtaining an average signal power level P_{A} for the bursts. If the average level P_{A} is greater than a predetermined level, affirm the reliability of the USF value and the reliability analysis module 84 outputs a positive signal. Otherwise the reliability analysis module 84 outputs a negative signal.

In these embodiments, the reliability analysis module 84 uses probability and statistics to check the trustworthiness of the USF value and sets the predetermined values according to the different coding schemes. It should also be noted that the present invention reliability analysis module 84 could also use other calculation methods to check the trustworthiness of the USF value and the present invention is not limited to the examples shown above.

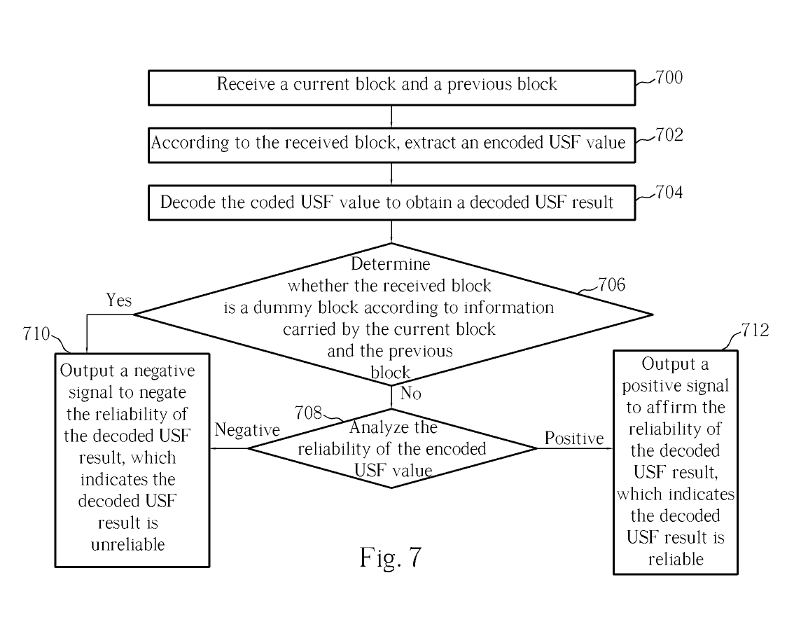

In the above disclosure, the dummy block determination is achieved according to information of only one received block. Actually, the dummy block determination can be achived according information of two received blocks. Here, please refer to FIG. 7, which is another flow chart describing the USF reliability analysis operation performed in the receiver shown in FIG. 5.

Step 700: Receive a current block and a previous block.

Step 702: According to the received blocks, extract an encoded USF value.

Step 704: Decode the coded USF value to obtain a decoded USF result.

Step 706: Determine whether the current block is a dummy block according to information carried by the current block and the previous block. If yes, proceed to step 710; otherwise, proceed to step 708.

Step 708: Analyze the reliability of the encoded USF value. If the result is negative, proceed to step 710; otherwise, proceed to step 712.

Step 710: Output a negative signal to negate the reliability of the decoded USF result, which indicates the decoded USF result is unreliable.

Step 712: Output a positive signal to affirm the reliability of the decoded USF result, which indicates the decoded USF result is reliable.

In step 700, the receiver 70 receives not only the current block, but also a previous block, where the previous block is received prior to the current block. In other words, in a preferred embodiment, the previous block is a block successive to the current block.

And then, as mentioned previously, each of the current block and the previous block comprises four bursts. Similarly, the equalizer 74 of the receiver 70 is used to calculate a signal quality indicator for each burst. Each burst's signal quality indicator is passed to the dummy block detection module 82. The signal quality indicator is a numerical value used to correspond to the quality situation of the burst. As an implementation example, the signal quality indicator could be a signal to noise ratio, a signal power, or a bit error rate.

As mentioned previously, it is already known that the characteristic of a dummy block is that each burst in the dummy block does not pass through encoding protection, and has been carefully designed such that the signal quality indicator of each burst in a dummy block will have a low value. Because of this, when the signal quality indicator is of a low value, this represents that the burst is possibly a dummy burst. Using the above mentioned dummy block and dummy burst characteristics, the dummy block detection module 82, according to each burst's signal quality indicator, determines whether or not the block is a dummy block. Using these guidelines for step 706, there can be several different implementations as described in the following examples.

A first method for determining dummy blocks by the detection module 82 involves calculating an average signal quality indicator Q_{A} for all the eight bursts in the received block and the previous block. If the average value Q_{A} is less than a predetermined level, the detection module 82 determines that the current block is a dummy block. Otherwise, the detection module 82 determines the current block to not be a dummy block.

A second method for determining dummy blocks by the detection module 82 involves determining whether each burst in the received block is a dummy burst. If a burst's signal quality indicator is less than a predetermined level, determine the burst to be a dummy burst. If the number of dummy bursts in the received block is greater than a predetermined number, determine the received block to be a dummy block.

A third method for determining dummy blocks by the detection module 82 involves calculating a maximum value signal quality indicator Q_{M} for all the eight bursts in the received block and the previous block. If the maximum value Q_{M} is less than a predetermined level, this represents that all bursts are possibly dummy bursts and the current block is also probably a dummy block. Therefore, the detection module 82 determines that the current block is a dummy block if the maximum value Q_{M} is less than a predetermined level. Otherwise, the detection module 82 determines the current block to not be a dummy block.

Please note, the above-mentioned step 706 discloses other methods for determining whether a currnet block is a dummy block. As long as the current block is determined as the dummy block, when the reliability analysis mode 84 receives the result outputted by the dummy block detection module 82, the reliability analysis module 84 outputs a negative signal.

Furthermore, please note that the following steps 708, 710, 712 are substantially the same as the above steps 108, 110, and 112, and the further illustration is therefore omitted here. To sum up, through the steps 708, 710, 712, the reliability of the USF value can be determined.

Please note, the step 704 is an optional step. That is, the present invention can determine whether the current block is a dummy block first. And only if the current block is not a dummy block, the present invention perform the decoding operation on the current block to obtain the decoded USF result. This change also obeys the spirit of the present invention.

Furthermore, the order of the steps 704 and 706 is only utilized as an embodiment, not a limitation of the present invention. That is, the present invention can simultaneously perform the decoding operation and the determination of the dummy block. This change also obeys the spirit of the present invention.

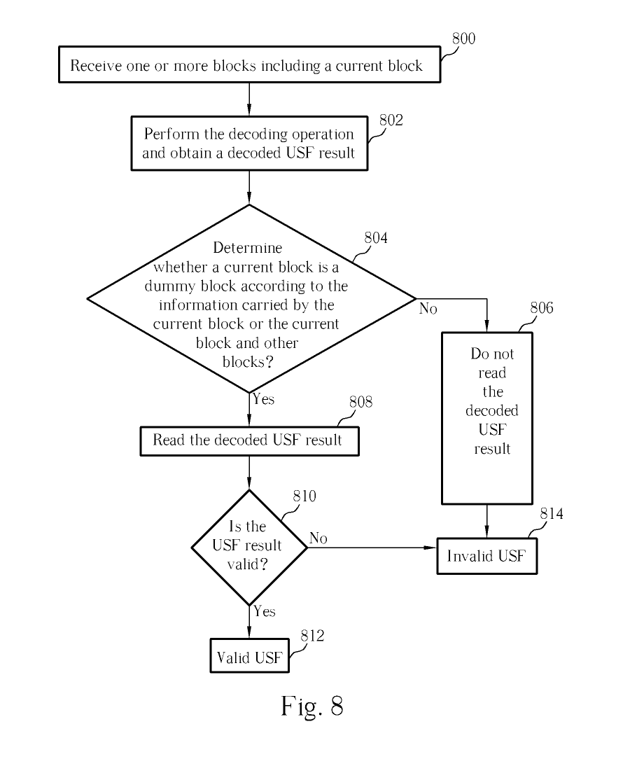

Please refer to FIG. 8, which is a flow chart integrating the flow charts FIG. 6 and FIG. 7. It comprises the following steps:

Step 800: Receive one or more blocks including a current block;

Step 802: Perform the decoding operation and obtain a decoded USF result;

Step 804: Determine whether a current block is a dummy block according to the information carried by the current block or the current block and other blocks; if yes, go to step 806; otherwise, go to step 808;

Step 806: Do not read the decoded USF result; and go to step 814;

Step 808: Read the decoded USF result;

Step 810: Is the USF result valid? If yes, go to step 812; otherwise, go to step 814;

Step 812: valid USF;

Step 814: invalid USF.

First, as mentioned previously, one or more blocks including the current block is received (step 800). And the receiver performs the decoding operation on the current block (surely, including the encoded USF value) to obtain the coded USF value (step 802).

And then, the receiver 70 determines whether the current block is a dummy block (step 804). As mentioned previously, the receiver 70 can calculate the above-mentioned signal quality indicators, the block quality indicator, the USF correlation indicators, or etc. Therefore, the receiver 70 can utilize these calculated data to determine whether the current block is a dummy block.

If the current block is a dummy block, the decoded USF result, which is determined in step 806, is no longer read for further utilization (step 806). Therefore, the decoded USF result is regarded as an invalid USF (step 814).

On the other hand, if the current block is not determined as a dummy block. The decoded USF result is read and validated in step 810. As mentioned above, there are a lot of ways for validating the USF result to determine whether the USF result is valid. For example, the USF correlation indicators can be utilized to validate the decoded USF result.

Therefore, after the validation of step 810, if the decoded USF result passes the validation, the decoded USF result is regarded as a valid USF (step 812). Otherwise, the decoded USF result is regarded as an invalid USF (step 814).

From the flow chart show in FIG. 8 and the above disclosure, those skilled in the art can clearly know the operations and procedures of determining the dummy block and validating the decoded USF result. Therefore, further illustrations are omitted here for simplicity.

Similarly, the step 802 is an optional step. The present invention can first determine whether the current block is a dummy block. And only if the current block is not a dummy block, the present invention performs the decoding operation on the current block to obtain the decoded USF result. This change also obeys the spirit of the present invention.

Furthermore, the order of the steps 802 and 804 is also utilized as an embodiment, not a limitation of the present invention. The present invention can simultaneously perform the decoding operation and the determination of the dummy block. This change also obeys the spirit of the present invention.

According to the present invention, the USF reliability is analyzed in the receiver, and the user end device can clearly determine whether or not to use the decoded USF value. This greatly reduces the chance of mistakenly using an invalid USF. Especially in the case that the received block is a dummy block, the signal strength is too low, or noise levels are too high, the related art will mistakenly use and decode the USF value. This leads to invalid decisions based on the mistaken USF. As such, the present invention reduces timeouts by the user end device T3180 and T3182 timers and the associated communication link disconnects. Situations where the T3180 timer cannot timeout and is therefore unable to disconnect the link and other situations causing communication link interference or disconnects are also reduced. In this way, the present invention assures the stability of the communication link between the user end device and base station.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of analyzing a reliability of a flag value outputted by a transmitter, after the transmitter has encoded the flag value, the flag value being included in a current block, the method comprising:
receiving a previous block transmitted prior to the current block and the current block, the current block and the previous block each including a plurality of bursts;
determining whether the current block is a dummy block according to the bursts of the previous block and the current block; and
determining the flag value as invalid if the current block is determined as a dummy block.

2. The method of claim 1, wherein the current block is received immediately after the previous block.

3. The method of claim 1, wherein the step of determining whether the current block is a dummy block comprises:
calculating signal quality indicators of the bursts of the previous block and the current block, and
determining whether the current block is a dummy block according to the signal quality indicators of the bursts.

4. The method of claim 3, wherein the step of determining whether the current block is a dummy block according to the signal quality indicators of the bursts comprises:
calculating an average of all signal quality indicators of the bursts of the current block and the previous block; and
determining that the current block is a dummy block if the average is less than a threshold.

5. The method of claim 3, wherein the step of determining whether the current block is a dummy block according to the signal quality indicators of the bursts comprises:
determining a burst is a dummy burst if the signal quality indicator of the burst is less than a first threshold; and
determining that the current block is a dummy block if a number of dummy bursts of the current block and the previous block is greater than a second threshold.

6. The method of claim 3, wherein the step of determining whether the current block is a dummy block according to the signal quality indicators of the bursts comprises:
determining that the current block is a dummy block if a maximum of the quality indicators of the bursts is less than a threshold.

7. The method of claim 3, wherein each of the signal quality indicators is a signal-to-noise ratio.

8. The method of claim 1, wherein the flag value is an uplink status flag (USF) value.

9. A flag reliability analysis apparatus for analyzing a reliability of a flag value outputted by a transmitter, after the transmitter has encoded the flag value, the flag value being included in a current block, the flag reliability analyzing device comprising:
a receiving module, for receiving a previous block transmitted prior to the current block and the current block; wherein each of the current block and the previous block comprises a plurality of bursts; and
a dummy block detecting module, for determining whether the current block is a dummy block according to the bursts of the previous block and the current block and determining the flag value as invalid if the current block is determined as a dummy block.

10. The flag reliability analysis apparatus of claim 9, wherein the current block is received immediately after the previous block.

11. The flag reliability analysis apparatus of claim 9, wherein the receiving module further calculates signal quality indicators of the bursts of the previous block and the current block, and the dummy block detecting module determines whether the current block is a dummy block according to the signal quality indicators of the bursts.

12. The flag reliability analysis apparatus of claim 11, wherein the dummy block detecting module further calculates an average of all signal quality indicators of the bursts of the current block and the previous block, and determines that the current block is a dummy block if the average is less than a threshold.

13. The flag reliability analysis apparatus of claim 11, wherein the dummy block detecting module further determines that a burst is a dummy burst if the signal quality indicator of the burst is less than a first threshold; and determines that the current block is a dummy block if a number of dummy bursts of the current block and the previous block is greater than a second threshold.

14. The flag reliability analysis apparatus of claim 11, wherein the dummy block detecting module further determines that the current block is a dummy block if a maximum of the quality indicators of the bursts is less than a threshold.

15. The flag reliability analysis apparatus of claim 11, wherein each of the signal quality indicators is a signal-to-noise ratio.

16. The flag reliability analysis apparatus of claim 11, wherein the flag value is an uplink status flag (USF) value.

17. A method of analyzing the reliability of a flag value outputted by a transmitter, after the transmitter has encoded the flag value, the flag value being included in a current block, the method comprising:
receiving the current block, the current block including a plurality of bursts;
calculating a signal quality indicator of each burst of the current block, and determining a block quality indicator according to the signal quality indicators of the bursts of the current block;
performing a correlation operation on the encoded flag value and all possible values of the coded flag value to obtain a plurality of coded flag correlation indicators and then determining an specific indicator according to the coded flag correlation indicators;
performing a predetermined calculation utilizing the block quality indicator and the specific indicator to obtain a calculation result; and
determining that the current block is a dummy block according to the calculation result and determining that the flag value as invalid if the current block is determined as a dummy block.

18. The method of claim 17, wherein the block quality indicator is equal to a maximum of the signal quality indicators of the bursts.

19. The method of claim 17, wherein each of signal quality indicators is a signal-to-noise ratio.

20. The method of claim 17, wherein the block quality indicator is equal to an average of the signal quality indicators of the bursts.

21. The method of claim 17, wherein the specific indicator is equal to a maximum of the coded flag correlation indicators.

22. The method of claim 17, wherein the specific indicator is equal to a difference between a first maximum and a second maximum of the coded flag correlation indicators.

23. The method of claim 17, wherein the step of performing the predetermined calculation comprises:
substituting the block quality indicator and the specific indicator into an equation; and
the step of determining that the current block is a dummy block according to the calculation result is:
if the block quality indicator and the specific indicator comply with the equation, determining that the current block is a dummy block.

24. The method of claim 17, wherein the flag value is an uplink status flag (USF) value.

25. A flag reliability analysis apparatus for analyzing the reliability of a flag value outputted by a transmitter, after the transmitter has encoded the flag value, the flag value being included in a current block, the flag reliability analysis apparatus comprising:
a receiving module for receiving the current block including a plurality of bursts, reading an encoded flag value transmitted via the current block and decoding the encoded flag value to obtain the flag value, calculating signal quality indicators of each burst of the current block, determining a block quality indicator according to the signal quality indicators, performing a correlation operation on the encoded flag value and all possible values of the coded flag value to obtain a plurality of coded flag correlation indicators and then determining an specific indicator according to the coded flag correlation indicators, and performing a predetermined calculation utilizing the block quality indicator and the specific indicator to obtain a calculation result; and
a dummy block detecting module, for determining that the current block is a dummy block according to the calculation result and determining that the flag value as invalid if the current block is determined as a dummy block.

26. The flag reliability analysis apparatus of claim 25, wherein the block quality indicator is equal to a maximum of the signal quality indicators of the bursts.

27. The flag reliability analysis apparatus of claim 25, wherein each of signal quality indicators is a signal-to-noise ratio.

28. The flag reliability analysis apparatus of claim 25, wherein the block quality indicator is equal to an average of the signal quality indicators of the bursts.

29. The flag reliability analysis apparatus of claim 25, wherein the specific indicator is equal to a maximum of the coded flag correlation indicators.

30. The flag reliability analysis apparatus of claim 25, wherein the specific indicator is equal to a difference between a first maximum and a second maximum of the coded flag correlation indicators.

31. The flag reliability analysis apparatus of claim 25, wherein receiving module substitutes the block quality indicator and the specific indicator into an equation and the dummy block detecting module determining that the current block is a dummy block if the block quality indicator and the specific indicator comply with the equation.

32. The flag reliability analysis apparatus of claim 25, wherein the flag value is an uplink status flag (USF) value.
